(19) United States
(12) Patent Application Publication
(10) Pub. No.: US 2017/0336187 A1
(43) Pub. Date: Nov. 23, 2017

(54) Square Device

(71) Applicant: Randall Alan Horton, Vail, CO (US)

(72) Inventor: Randall Alan Horton, Vail, CO (US)

(21) Appl. No.: 15/593,620

(22) Filed: May 12, 2017

Related U.S. Application Data
(60) Provisional application No. 62/339,267, filed on May 20, 2016.

(51) Int. Cl. G01B 3/00; G01B 3/56; G01B 3/04

(52) U.S. Cl. CPC G01B 3/002; G01B 3/04; G01B 3/566

(57) ABSTRACT

A square device and method of operation is disclosed. An example square device includes a first leg having a substantially same size height as width, and a second leg having a substantially same size height as width, the first leg and the second leg joined to form a substantially L-shape. The example square device also includes a substantially V-shaped groove formed all along an outward facing side of the first leg and the second leg, and a substantially flat clamping surface formed all along an inward facing side of the first leg and the second leg. When a first working article is received in the V-shaped groove formed along the first leg, and a second working article is received in the V-shaped groove formed along the second leg, the first working article is held in a substantially perpendicular orientation relative to the second working article.

### PRIORITY CLAIM AND CROSS REFERENCE TO RELATED APPLICATION

This application claims the priority benefit of U.S. Provisional Patent Application Nos. 62/339,267 filed May 20, 2016 for “Square Device,” hereby incorporated by reference in its entirety as though fully set forth herein.

### BACKGROUND

A framing square is a tool used by construction workers, wood workers, and others, primarily as a measurement tool and/or as a guide for drawing horizontal lines. Framing squares are generally L-shaped or T-shaped, and come in various sizes.

A framing square is relatively flat, making it difficult to pick up and move around. It is readily misplaced (e.g., under a board or other object) and difficult to locate visually in the shop or at the worksite because it is flat. Being flat also makes the framing square difficult to handle, especially when wearing gloves. During use, the framing square can slide under the edge of the article being worked on. This is particularly true if the article is a typical piece of rounded-edge lumber (e.g., a two-by-four or other “two-by”).

### BRIEF DESCRIPTION OF THE DRAWINGS

FIG. 1 is a top-front perspective view of an example square device.

FIG. 2 is a top-rear perspective view of the example square device.

FIG. 3 is a right-side perspective view of the example square device.

FIG. 4 is a left-side perspective view of the example square device.

FIG. 5 is a bottom perspective view of the example square device.

FIG. 6 is a top front view of the example square device.

FIG. 7 is a bottom front view of the example square device.

FIG. 8 illustrates the example square device as it may be implemented to hold cylindrically shaped working articles.

FIG. 9 illustrates the example square device as it may be implemented to hold a cylindrically shaped working article and a rectangular shaped working article.

FIG. 10 illustrates the example square device as it may be implemented to hold rectangular shaped working articles.

### DETAILED DESCRIPTION

A square device is disclosed. An example square device includes a first leg having a substantially same size height as width, and a second leg having a substantially same size height as width, the first leg and the second leg joined to form a substantially L-shape. The example square device also includes a substantially V-shaped groove formed all along an outward facing side of the first leg and the second leg, and a substantially flat clamping surface formed all along an inward facing side of the first leg and the second leg.

In an example, the square device may include measurement markings that are readily visible. In addition, the example square device may include angle marking that make it easy to find and mark angles during a project.

The square device is a versatile tool that can be implemented in construction, wood working, welding, metal working, and many other industries. An example of the square device is configured such that it does not slide under a work-piece, and is readily located visually at the worksite. The square device readily grasped during handling, even when wearing work gloves.

Methods of implementing the square device are also disclosed. In an example, a first working article is received in the V-shaped groove formed along the first leg. A second working article is received in the V-shaped groove formed along the second leg. Accordingly, the first working article is held by the square device in a substantially perpendicular orientation relative to the second working article. In an example, the square device can be implemented to hold different shape articles (e.g., flat, round, or angled stock).

In an example, the user (e.g., a craftsman) can implement the square device to hold the article(s) being worked on at about 90 degrees relative to one another. For example, the square device may help hold the articles at about 90 degrees while the user secures the articles, e.g., with screws or clamps. As such, the square device eliminates the need for a separate jig or asking another person for help holding the articles during assembly.

Before continuing, it is noted that as used herein, the terms “includes” and “including” mean, but is not limited to, “includes” or “including” and “includes at least” or “including at least.” The term “based on” means “based on” and “based at least in part on.”

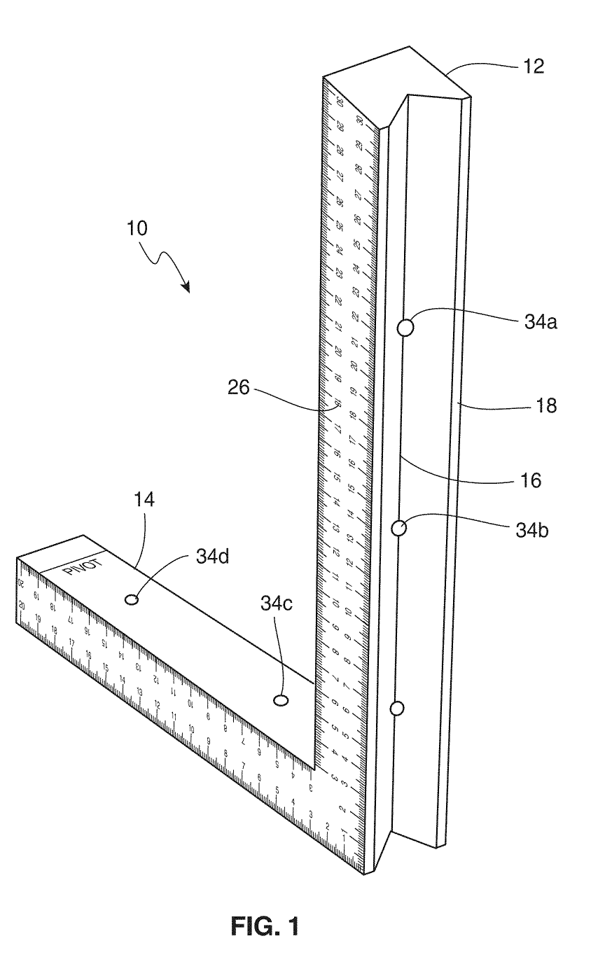

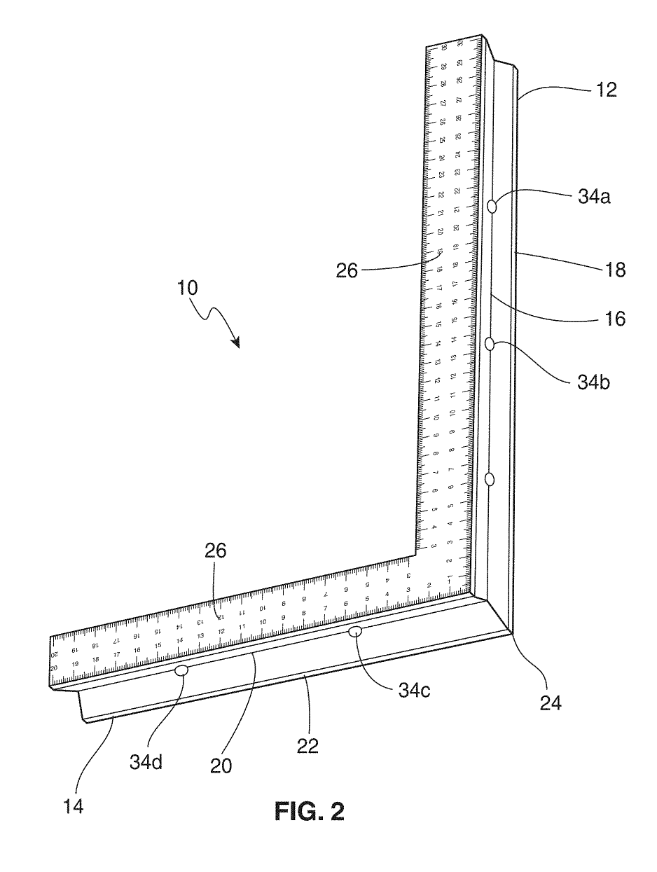

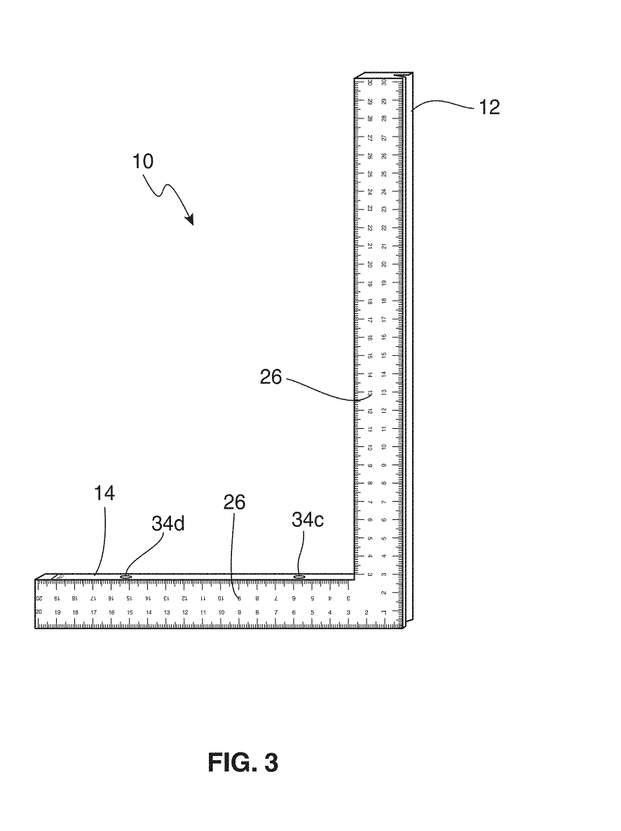

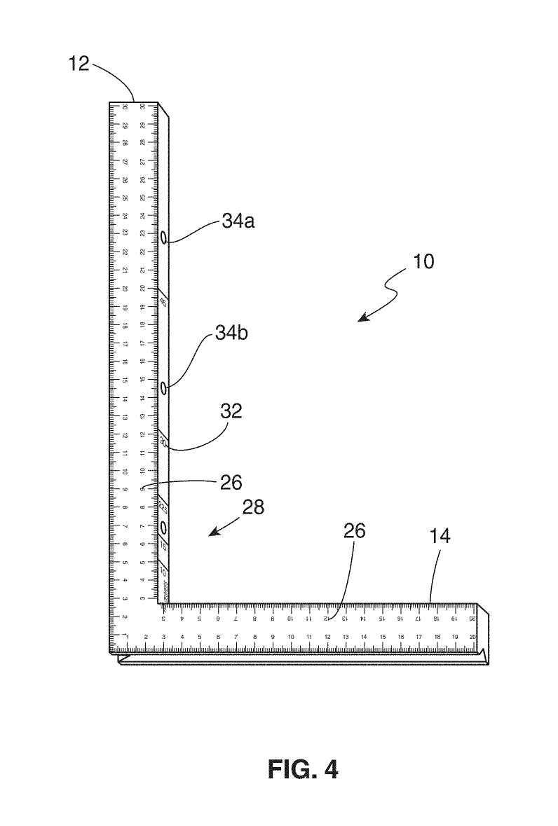

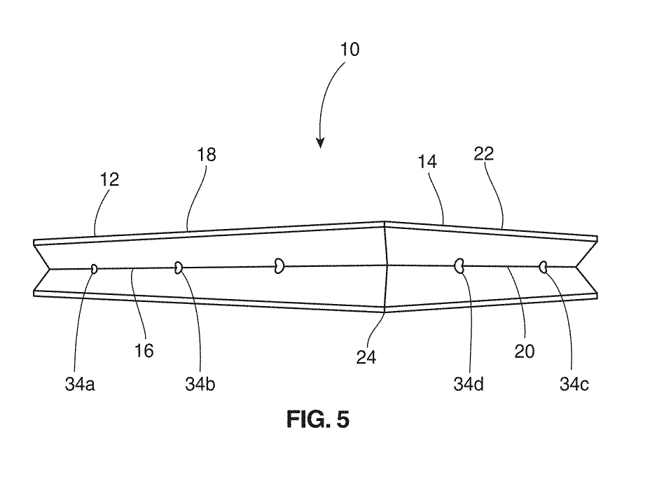

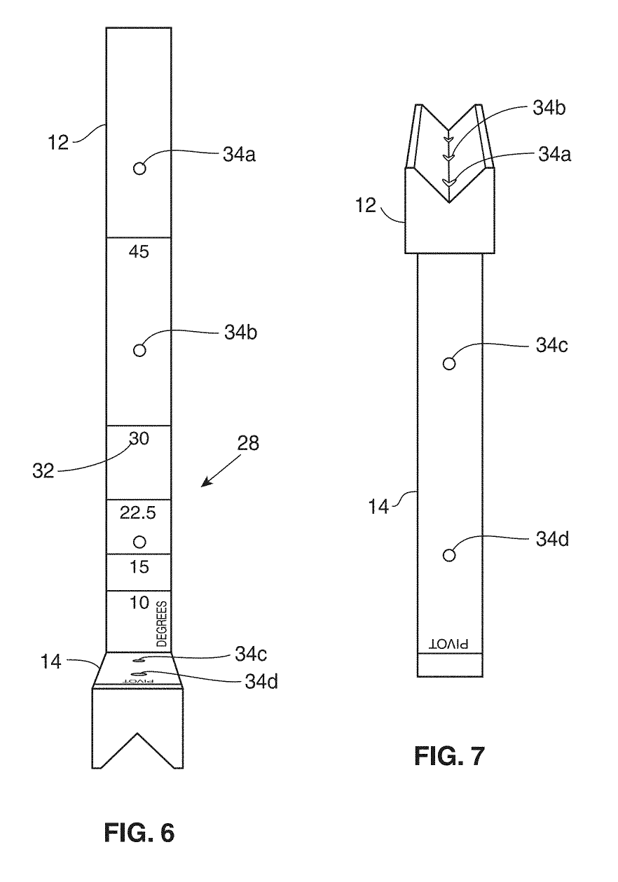

FIG. 1 is a top-front perspective view of an example square device 10. FIG. 2 is a top-rear perspective view of the example square device 10. FIG. 3 is a right-side perspective view of the example square device 10. FIG. 4 is a left-side perspective view of the example square device 10. FIG. 5 is a bottom perspective view of the example square device 10. FIG. 6 is a top front view of the example square device 10. FIG. 7 is a bottom front view of the example square device 10.

The square device 10 may be manufactured of any suitable material, including but not limited to plastic, metal, composite, or even a combination of materials (e.g., plastic reinforced with metal). The square device 10 may be made solid, hollow, or a combination of hollow and solid portions. In an example, the square device 10 is made of aluminum so that if a welder is joining two pieces of steel, the hot steel balls generated from the welding do not stick to the square device 10.

In an example, the square device 10 includes a first leg 12 and a second leg 14. The first leg 12 and/or the second leg 14 may have at least one rounded edge and/or at least one square or “sharp” edge.

In an example, the first leg 12 is connected to the second leg 14 in a substantially L-shape. That is, the first leg 12 and the second leg 14 are substantially perpendicular to one another.

Other examples may include the first leg 12 provided at any predetermined angle (e.g., 30 degrees, 60 degrees, etc.) relative to the second leg. In another example, the angle between the first leg 12 and the second leg 14 may be adjustable (e.g., pivot at the connection between the first leg 12 and the second leg 14).

In an example, the square device 10 is not flat. That is, the height of the first leg 12 and the second leg 14 is approximately the same size as the width of the first leg 12 and the second leg 14. The square device 10 may have square or rectangular legs so that it will not slide under or fall off the working article(s) that it is being implemented to maintain square.

As such, the square device 10 can stand on both legs 12 and 14. It is wide enough so that it does not slide under the working article (e.g., the material that is being worked on). In addition, the girth of the square device 10 makes it more easily handled by the craftsman.

In the example shown in the drawings, the first leg 12 and the second leg have a substantially square profile. However, other examples may include a substantially rectangular profile. For example, the height of the first leg 12 and/or the second leg 14 may be larger or smaller than the width of the first leg 12 and/or the second leg 14.

In an example, the square device 10 has a substantially V-shaped cross section or profile. In the example shown in the drawings, the V-shaped profile is configured as a groove 16 extending along an outward facing surface 18 of the first leg 12. The V-shaped profile is also configured as a groove 20 extending along an outward facing surface 22 of the second leg 14.

In an example, the substantially V-shape profile (e.g., groove 16) on one side of the first leg 12 geometrically matches a substantially V-shape profile (e.g., groove 20) on one side of the second leg 14 at an outside corner 24 where the first leg 12 is connected to the second leg 14.

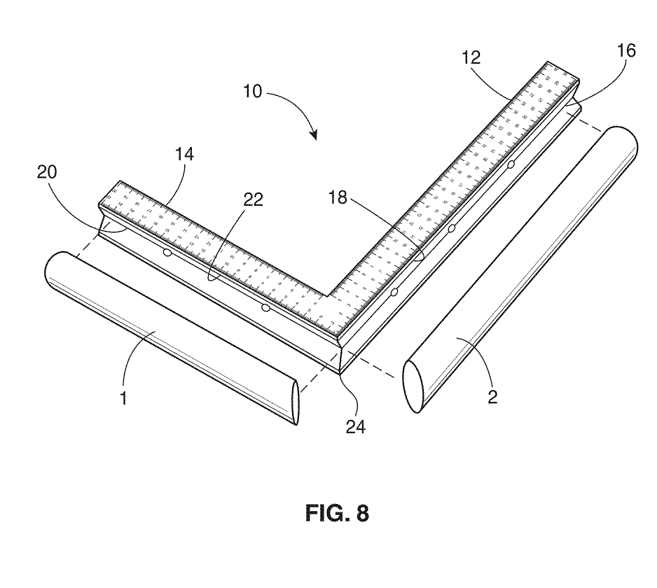

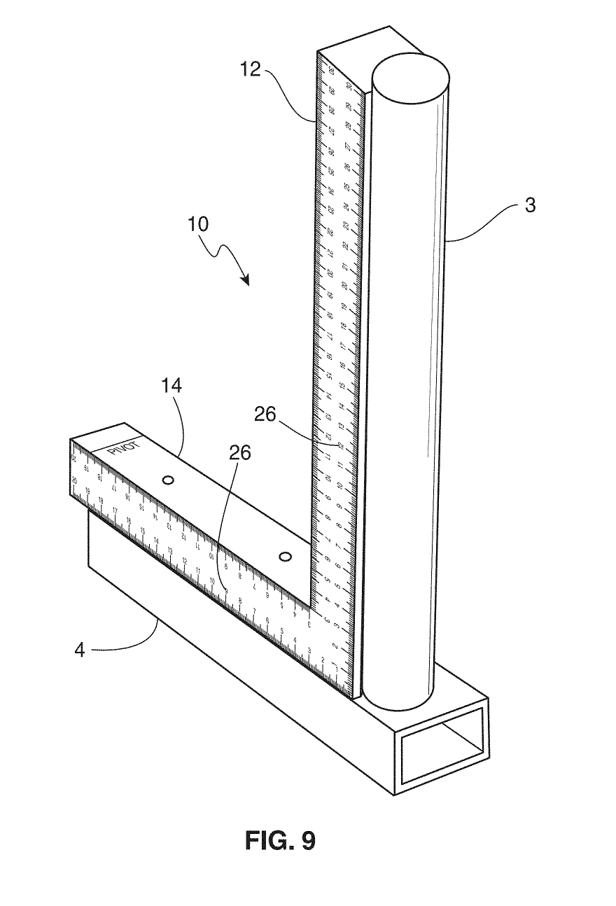

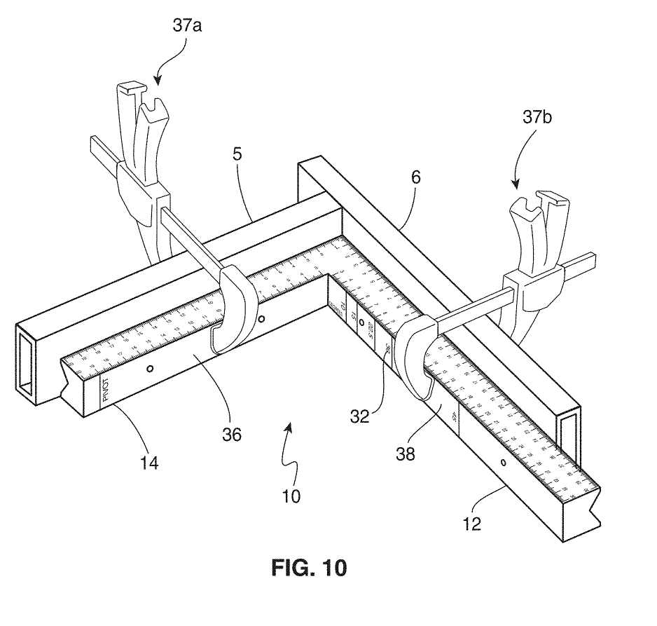

As such, a rounded or angular shaped working article can be at least partly received within the grooves 16 and/or 20 (see, e.g., FIGS. 8 and 9). In addition, the grooves 16 and 20 do not prevent or interfere with a flat shaped working article (see, e.g., FIGS. 9 and 10).

Other configurations are also contemplated. For example, only one of the first leg 12 and the second leg 14 may include the V-shaped profile. In addition, the example of the square device 10 shown in the drawings includes the V-shaped profile extending the entire length of the first leg 12 and the entire length of the second leg 14. However, the V-shaped profile need not extend the entire length. In other configurations, the V-shaped profile may be omitted altogether, and for example, all sides of the legs may be substantially flat.

Still other examples are also contemplated. For example, the first leg 12 and/or the second leg 14 may include a rounded (e.g., half-circle) shaped profile, a double-V (e.g., a “W” shaped) profile, or any other shape profile.

The square device 10 may also include measurement markings 26 on at least one of the first leg 12 and the second leg 14. The measurement markings 26 may be provided only on one face of the legs 12 and 14, or on multiple sides of the legs 12 and 14. In addition, the measurement markings 26 may also be provided adjacent to and/or within one or both of the V-shaped groove 16 and/or groove 20.

In an example, the measurement markings 26 are printed directly on the square device, or on tape or otherwise printed and adhered to the surface(s) of the square device 10. In another example, the measurement markings 26 are imprinted or engraved or otherwise formed in the material of the square device 10.

The square device 10 may also include angle markings 28 on at least one of the first leg 12 and the second leg 14. In an example, the angle markings 28 include an angle indicator 30 on one of the legs 12 or 14, and a reference indicator 32 on the other of the legs 12 or 14.

In an example, the angle markings 28 are printed directly on the square device, or on tape or otherwise printed and adhered to the surface(s) of the square device 10. In another example, the angle markings 28 are imprinted or engraved or otherwise formed in the material of the square device 10.

The square device 10 may also include pre-drilled holes or openings 34a-d may be otherwise formed in the first leg 12 and/or the second leg 14. The openings 34a-d may be implemented to attach the square device 10 to a working article. For example, screws or bolts (not shown) may be provided through one or more of the openings 34a-d and the working article(s). In another example, the openings 34a-d may be implemented as a guide or template to drill holes into a working article.

The square device 10 may have a substantially flat clamping surface 36 on the first leg 12, and a substantially flat clamping surface 38 on the second leg 14 for clamps (e.g., clamps 37a and 37b). The clamping surfaces 36 and 38 are positioned opposite the V-shaped grooves 16 and 20, respectively. As such, a working article received at least partly within the V-shaped grooves 16 and/or 20 can be clamped to the side(s) of the first and/or second legs 12 and 14 (e.g., as shown in FIG. 10).

Before continuing, it should be noted that the examples described above are provided for purposes of illustration, and are not intended to be limiting. Other devices and/or device configurations may be utilized to carry out the operations described herein.

FIGS. 8-10 illustrate example operations implementing the square device 10. In an example, a first working article is received in the V-shaped groove 16 formed along the first leg 12. Also in this example, a second working article is received in the V-shaped groove 20 formed along the second leg 14. As such, the first working article is held in a substantially perpendicular orientation relative to the second working article.

FIG. 8 illustrates the example square device 10 as it may be implemented to hold cylindrically shaped working articles 1 and 2. FIG. 9 illustrates the example square device 10 as it may be implemented to hold a cylindrically shaped working article 3 and a rectangular shaped working article 4. FIG. 10 illustrates the example square device 10 as it may be implemented to hold two rectangular shaped working articles 5 and 6. Of course, the square device 10 may be implemented with any shape working articles.

In an example, the square device 10 is “L” shaped and flat on all sides so that it can be clamped to the working articles needing to be maintained in a square relation to one another. The square device 10 may have pre-drilled holes to be able to screw or otherwise the working articles to the square until they are joined to one another (e.g., by welding or otherwise).

Working articles can be clamped, screwed, or otherwise fastened to both legs 12 and 14 of the square device 10. As such, the working articles are held square (e.g., at about 90 degrees) relative to one another while the craftsman secures or joins the materials together. Pre-drilled holes may be provided in each leg 12 and 14, and each leg is made from a material (e.g., thick steel or aluminum) that can withstand a clamping force.

The width of each leg is configured for ease of handling, to stand on its own not requiring the workman to have an assistant to hold the square or need a third arm. The square can be clamped or screwed to the project. Angles are easy to mark and apply to the materials being worked on.

It is noted that the examples shown and described are provided for purposes of illustration and are not intended to be limiting. Still other examples are also contemplated.

1. A square device, comprising:
a first leg connected to a second leg in a substantially L-shape;
wherein a height of the first leg and the second leg is approximately the same size as a width of the first leg and the second leg.

2. The square device of claim 1, further comprising a substantially V-shape profile on one side of the first leg.

3. The square device of claim 1, further comprising a substantially V-shape profile on one side of the second leg.

4. The square device of claim 1, wherein a substantially V-shape profile on one side of the first leg geometrically matches a substantially V-shape profile on one side of the second leg at an outside corner where the first leg is connected to the second leg.

5. The square device of claim 1, further comprising measurement markings on at least one of the first leg and the second leg.

6. The square device of claim 1, further comprising angle markings on at least one of the first leg and the second leg.

7. The square device of claim 1, further comprising measurement markings within a V-shaped groove formed along a side of at least one of the first leg and the second leg.

8. The square device of claim 1, further comprising pre-drilled holes in at least one of the first leg and the second leg.

9. The square device of claim 1, wherein at least one of the first leg and the second leg has at least one square edge.

10. The square device of claim 1, wherein at least one of the first leg and the second leg has at least one rounded edge.

11. The square device of claim 1, wherein at least one of the first leg and the second leg is solid.

12. The square device of claim 1, wherein at least one of the first leg and the second leg is hollow.

13. The square device of claim 1, wherein the first leg has substantially flat clamping surface.

14. The square device of claim 1, wherein the second leg has substantially flat clamping surface.

15. The square device of claim 1, wherein the first leg has a V-shaped groove to receive a rounded or angular shaped working article.

16. The square device of claim 1, wherein the second leg has a V-shaped groove to receive a rounded or angular shaped working article.

17. The square device of claim 1, wherein the first leg has a V-shaped groove to receive a first working article, and the second leg has a V-shaped groove to receive a second working article, the first leg and the second leg maintaining the first working article substantially perpendicular to the second working article.

18. A square device, comprising:
a first leg having a height and a width and a length, the height and the width of the first leg being substantially the same size;
a second leg joined to the first leg to form a substantially L-shape, the second leg having a height and a width and a length, the height and the width of the second leg being substantially the same size;
a substantially V-shaped profile formed along an outward facing side of the first leg;
a substantially V-shaped profile formed along an outward facing side of the second leg;
a substantially flat clamping surface on an inward facing side of the first leg; and
a substantially flat clamping surface on an inward facing side of the second leg;

19. The square device of claim 18, wherein when a first working article is received in the V-shaped profile of the first leg and a second working article is received in the V-shaped profile of the second leg to maintain the first working article in a substantially perpendicular orientation relative to the second working article.

20. A square device, comprising:
a first leg having a substantially same size height as width;
a second leg having a substantially same size height as width, the first leg and the second leg joined to form a substantially L-shape;
a substantially V-shaped groove formed all along an outward facing side of the first leg and the second leg; and
a substantially flat clamping surface formed all along an inward facing side of the first leg and the second leg;
wherein when a first working article is received in the V-shaped groove formed along the first leg and a second working article is received in the V-shaped groove formed along the second leg, the first working article is held in a substantially perpendicular orientation relative to the second working article.
